(19) United States
(12) Patent Application Publication
(10) Pub. No.: US 2016/0054132 A1
(43) Pub. Date: Feb. 25, 2016

(54) Navigation Device, Method of Outputting an Electronic Map, and Method of Generating a Database

(71) Applicant: HARMAN BECKER AUTOMOTIVE SYSTEMS GMBH, Karlsbad (DE)

(72) Inventors: Marek STRASSENBURG-KLECIAK, Munchen (DE); Stavros MITRAKIS, Kirchheim-Heimstetten (DE)

(21) Appl. No.: 14/779,306

(22) PCT Filed: Apr. 5, 2013
(86) PCT No.: PCT/EP2013/057251

§ 371 Date: Sep. 22, 2015

(51) Int. Cl. G01C 21/20; G06T 11/20

(52) U.S. Cl. CPC G01C 21/20; G06T 11/20

(57) ABSTRACT

A navigation device comprises a database storing footprint data for buildings which define a footprint of the respective building. For at least some buildings, the footprint data comprise position information defining a position of the building, a length indicator indicating a length of a rectangular portion of the footprint, and a width indicator indicating a width of the rectangular portion of the footprint. The length indicator is stored in a single byte. The width indicator is stored in another single byte.

### TECHNICAL FIELD

Embodiment of the invention relate to a navigation device comprising a database storing data for generating electronic maps. Embodiment of the invention relate in particular to such devices and methods in which electronic maps showing buildings may be output using data stored in the database.

### BACKGROUND

Optical output devices are widely used in navigation devices. Such output devices may be used for outputting electronic maps. Electronic maps may be displayed on screens of small and/or portable devices and have the advantage of being versatile and compact. Data displayed on electronic maps may be easily modified and adapted, e.g., by changing the scale of the map portion displayed, by displaying additional objects that might be of relevance to the user, such as directional arrows indicating a direction change in a navigation device, or by highlighting objects that may be of relevance to the user. Driver assist functions may be implemented in this manner for vehicle navigation devices.

Electronic maps which include information on buildings may be of particular value to the user owing to their high recognition quality. Two- or three-dimensional maps may be generated which include information on buildings. For a two-dimensional map, footprints of buildings may be displayed. For a three-dimensional map, graphical representations of buildings may be reconstructed using information on a footprint of a building. The recognition of an environmental region, such as a street intersection, may be facilitated when a map is output which shows buildings in two-dimensional or three-dimensional form.

While it is desirable to include information on buildings in electronic maps, the additional data which must be stored in a database may significantly add to storage space requirements. In one approach, information on a footprint of a building may be stored by storing the coordinates of all vertices of the footprint. While such an approach may be applied to virtually any footprint, the amount of data which must be stored for each footprint may be large. In another approach, information on the footprint of a building may be stored by storing the coordinates of a vertex of the footprint and the Cartesian coordinates of all edge vectors. Again, the amount of data which must be stored for each footprint may be large.

### SUMMARY

There is a continued need for navigation devices and methods which allow building footprints to be defined in a compact manner.

In devices and methods according to embodiments, footprint data for a building is stored in a particularly compact manner when the footprint is rectangular, i.e. when the footprint consists of one rectangular portion, or is composed only of rectangular portions. To this end, a length indicator and a width indicator are determined which respectively have at most eight bits. The length indicator may define the length of a rectangular portion of the footprint in units of a quantization step size. The width indicator may define the width of the rectangular portion in units of the same quantization step size. The quantization step size may have a default value, unless the length or width of the rectangular portion exceeds a threshold value.

Information on a position of a characteristic point of the footprint may also be stored in the database. For illustration, position information defining a position of one corner or of a center point of the footprint may be stored in the database to define the position of the building. Orientation information defining an orientation of the footprint may optionally also be stored in the database.

According to an embodiment, a navigation device is provided. The navigation device comprises an optical output device, a database, and a processing device. The database stores data for a plurality of buildings. The data for at least some buildings respectively comprises footprint data. The footprint data defines a footprint of the respective building and comprises position information, a length indicator, and a width indicator. The position information defines a position of the building. The length indicator indicates a length of a rectangular portion of the footprint and is stored in a single byte. The width indicator indicates a width of the rectangular portion of the footprint and is stored in another single byte. The processing device is coupled to the database and is configured to control the optical output device as a function of the position information, the length indicator and the width indicator stored for a building in the database to output a graphical representation of the building.

According to another embodiment, a method of outputting an electronic map is provided. The method comprises retrieving data for a building from a database. The database stores data for a plurality of buildings. The data for at least some buildings respectively comprises footprint data. The footprint data defines a footprint of the respective building and comprises position information, a length indicator, and a width indicator. The position information defines a position of the building. The length indicator indicates a length of a rectangular portion of the footprint and is stored in a single byte. The method comprises outputting a graphical representation of the building via an optical output device. The graphical representation is generated as a function of the position information, the length indicator and the width indicator stored for the building in the database.

According to another embodiment, a method of generating a database for a navigation device is provided. The method comprises determining whether a footprint of a building is composed of at least one rectangular portion. If the footprint is composed of the at least one rectangular portion, a length indicator is determined which has at most eight bits and which indicates a length of a rectangular portion of the footprint. If the footprint is composed of the at least one rectangular portion, a width indicator is determined which has at most eight bits and which indicates a width of the rectangular portion. Footprint data for the building is stored in the database. The footprint data is stored such that it includes position information defining a position of the building, the width indicator and the length indicator. The length indicator is stored in a single byte and the width indicator is stored in another single byte.

Embodiments of the invention store information on rectangular footprints of buildings in a particularly compact way. The length indicator and width indicator are respectively stored in one byte and define the dimensions of a rectangular portion of the footprint in a compact manner.

It is to be understood that the features mentioned above and those to be explained below can be used not only in the respective combinations indicated, but also in other combinations or in isolation. Other devices, methods, features and advantages of the invention will be or will become apparent to one with skill in the art upon examination of the following figures and detailed description.

### BRIEF DESCRIPTION OF THE DRAWINGS

The foregoing and other features of embodiments will become more apparent from the following detailed description of embodiments when read in conjunction with the accompanying drawings. In the drawings, like reference numerals refer to like elements.

FIG. 1 is a schematic block diagram of a navigation device according to an embodiment.

FIG. 2 is a schematic representation of a map database of a navigation device according to an embodiment.

FIG. 3 is a schematic representation of footprint data in a map database of a navigation device according to an embodiment.

FIG. 4 is an exemplary view of an electronic map generated using the map database of FIG. 3.

FIG. 5 is a schematic representation of footprint data in a map database of a navigation device according to another embodiment.

FIG. 6 is an exemplary view of an electronic map generated using the map database of FIG. 5.

FIG. 7 is a schematic representation of footprint data in a map database of a navigation device according to another embodiment.

FIG. 8 is a flow chart of a method of displaying an electronic map according to an embodiment.

FIG. 9 is a flow chart of a method of displaying an electronic map according to an embodiment.

FIG. 10 is a schematic representation of footprint data in a map database of a navigation device according to another embodiment.

FIG. 11 is an exemplary view of an electronic map generated using the map database of FIG. 10.

FIG. 12 is a flow chart of a method of generating a database according to an embodiment.

FIG. 13 is a schematic representation of footprint data in a map database of a navigation device according to another embodiment.

FIG. 14 is a schematic representation of footprint data in a map database of a navigation device according to another embodiment.

FIG. 15 is an exemplary view of an electronic map generated using the map database of FIG. 14.

### DETAILED DESCRIPTION

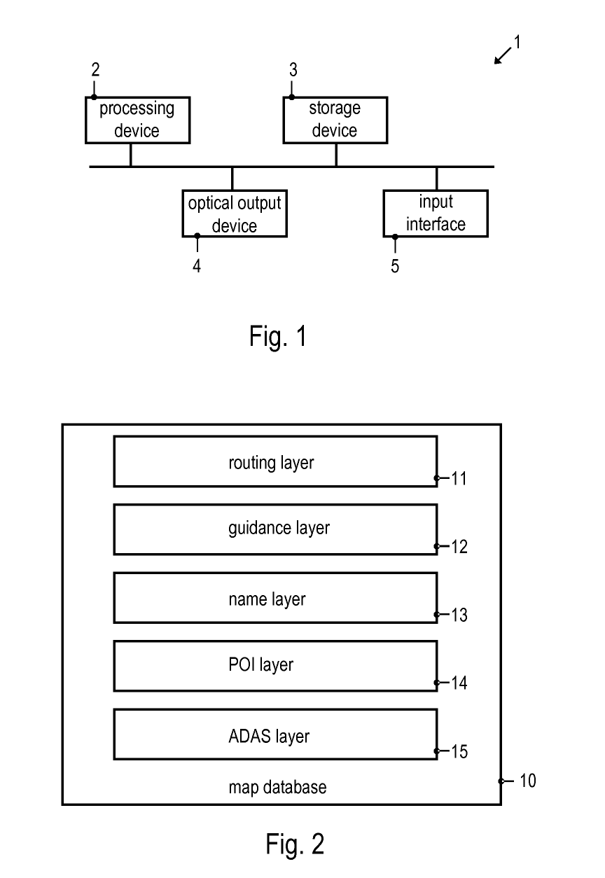

FIG. 1 schematically illustrates a navigation device 1 according to an embodiment. The navigation device 1 comprises a processing device 2 which controls operation of the navigation device 1. The processing device 2 may comprise a central processing unit, for example in form of one or more microprocessors, digital signal processors or application-specific integrated circuits. The processing device 2 may also include a graphics processor. The navigation device 1 further includes a database stored in a storage device 3. The storage device 3 may comprise any one, or any combination, of various types of memory, such as random access memory, flash memory or a hard drive, but also removable memories such as a compact disk (CD), a DVD, a memory card or the like. The storage device 3 may be a non-volatile storage medium in which the database is stored. The navigation device 1 also includes an output interface for outputting information to a user. The output interface includes an optical output device 4, which may comprise a screen and/or a projector. The navigation device 1 may also include an input interface 5.

The navigation device 1 may include additional components, such as a position sensor and/or a wireless receiver and/or a vehicle interface. The position sensor may be adapted to determine the current position of the vehicle in which the navigation device 1 is installed. The position sensor may comprise a GPS (Global Positioning System) sensor, a Galileo sensor, a position sensor based on mobile telecommunication networks and the like. The wireless receiver may be configured to receive information for updating the map database stored in the storage device 3. The vehicle interface may allow the processing device 2 to obtain information from other vehicle systems or vehicle status information via the vehicle interface. The vehicle interface may for example comprise a CAN (controller area network) or MOST (Media Oriented devices Transport) interface.

The storage device 3 stores a database defining map data. The database may include information for performing route search. In addition, the database also includes information for outputting graphical representations of buildings. The database includes footprint data which allows the footprints of buildings to be displayed on the electronic map under the control of the processing device 2. The processing device 2 controls the output interface 4 such that two- or three-dimensional building representations are output using the footprint data.

As will be explained in more detail in the following, the database 3 stores footprint data for buildings. For a building which has a rectangular footprint, the footprint data includes position information specifying a position of the building, a length indicator and a width indicator. The length indicator specifies the length of the footprint. The width indicator specifies the width of the footprint. The length of the footprint may be determined by multiplying the length indicator by a quantization step size. The width of the footprint may be determined by multiplying the width indicator by the quantization step size. The length indicator includes eight bits stored in a single byte. The width indicator includes eight bits stored in another single byte.

The length indicator may represent an integer number selected in the interval between 0 and 255, inclusive. The integer number defined by the length indicator may be a multiplier with which the quantization step size is multiplied to determine the length of the footprint. The length can thereby be defined in a discretized form, with the maximum error being half the quantization step size.

The width indicator may represent an integer number selected in the interval between 0 and 255, inclusive. The integer number defined by the width indicator may be a multiplier with which the quantization step size is multiplied to determine the width of the footprint. The width can thereby be defined in a discretized form, with the maximum error being half the quantization step size.

If the footprint has a length and/or width which exceeds a threshold, information on the quantization step size may be stored in the database. If the footprint has a length and a width which does not exceed the threshold, the quantization step size does not need to be stored in the database.

If the footprint of a building consists of several rectangular portions, a length indicator and width indicator may be stored in the database for each one of the several rectangular portions. The footprint of the building may be determined as union of the several rectangular portions.

If the footprint of a building is not rectangular and/or of if the footprint of a building cannot be decomposed into plural rectangles, the footprint data may store the positions of all corners of the respective footprint. In another implementation, the footprint data may store the position of one corner and the edge vectors of the various edges of the footprint.

The processing device 2 is configured to retrieve the position information, length indicator, width indicator and, if applicable, quantization step size for a building from the database. The processing device 2 may display buildings having rectangular footprints on an electronic map, with the retrieved length indicator and width indicator being used to respectively determine the lateral dimensions of the building.

FIG. 2 is a schematic representation of a database 10 which may be used in the navigation device 1. The database 10 having the structure explained in the following may be stored in a non-volatile storage device of the navigation device 1.

The map database 10 includes a plurality of layers 11-15. The layers may include a routing layer 11 which stores the information required for performing route searches and a guidance layer 12 which stores data required for route guidance. The map database 10 may include additional layers 13-15. A name layer 13 may includes references to road names, house numbers or similar. A point of interest (POI) layer 14 may include information on points of interest. An Advanced Driver Assistance System (ADAS) layer 15 may include data for Advanced Driver Assistance. Additional or alternative layers may be provided, such as a truck layer including specific information for trucks or lorries, a layer for phonetic representations, or a layer for basic map display.

The database 10 may be configured as a relational database. At least one of the layers of the database, e.g. the POI layer 14 or the guidance layer 12, may include footprint data for a plurality of buildings. This footprint data is used for outputting city models which include 2D or 3D representations of buildings.

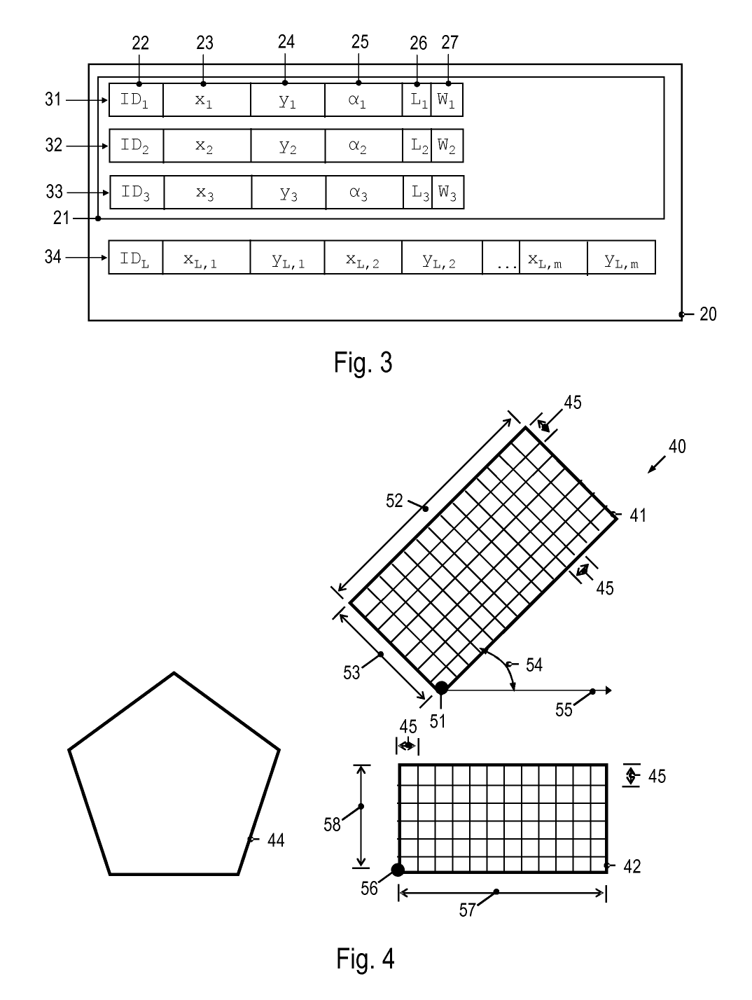

FIG. 3 is a schematic representation of database 20 which includes data defining building footprints. The database 20 may be stored in a non-volatile storage device of the navigation device 1.

The database 20 includes a data section 21 in which footprints of buildings having rectangular footprints are stored. The data section 21 may be a table. The data section 21 may be a table of a relational database. The data section 21 may include footprint data 31 representing a rectangular footprint of a building, and other footprint data 32, 33 respectively defining rectangular footprints of other buildings. The database 20 may include footprint data 34 for a building which has a footprint which cannot be decomposed into one or plural rectangular portions.

The footprint data 31-33 respectively includes position information defining a position of the footprint in a world reference frame. For illustration, the coordinates of a characteristic point of the footprint may be stored in the footprint data. The coordinates of one corner or of a center of the footprint may be stored in the footprint data. For illustration, the footprint data 31-33 may respectively include a data field 23 for storing a coordinate and another data field 24 for storing another coordinate of a corner of the footprint. The data field 23 may have a length greater than one byte. The data field 23 may have a length of eight bytes, of 16 bytes, or of 32 bytes, for example. The other data field 24 may have a length greater than one byte. The other data field 24 may have a length of eight bytes, of 16 bytes, or of 32 bytes, for example.

The footprint data 31-33 respectively includes a length indicator Lₘ and a width indicator Wₘ. The index m is a building index denoting a building. The length indicator Lₘ is stored in a single byte 26. The width indicator Wₘ is stored in another single byte 27. The length indicator Lₘ and the width indicator Wₘ is respectively defined by at most eight bits such that it can be stored in one byte.

The footprint data 31-33 may include additional information. For illustration, a data field 22 may be reserved for indicating an identifier for the respective building. The data field 22 may be omitted in some embodiments. For illustration, the database may have an index which defines at which location in the table 21 or in a database page the footprint data for a building is respectively stored. It is then not required to store the identifier in the footprint data.

For further illustration, the footprint data 31-33 may comprise orientation information. A data field 25 may be reserved to store the orientation information. The orientation information may define the orientation of one of the sides of the rectangular footprint in a world reference frame. The orientation information may be a numerical value indicating the angle between one side of the rectangular footprint and a coordinate axis. The data field 25 may have a length greater than one byte. The data field 25 may have a length of eight bytes, of 16 bytes, or of 32 bytes, for example.

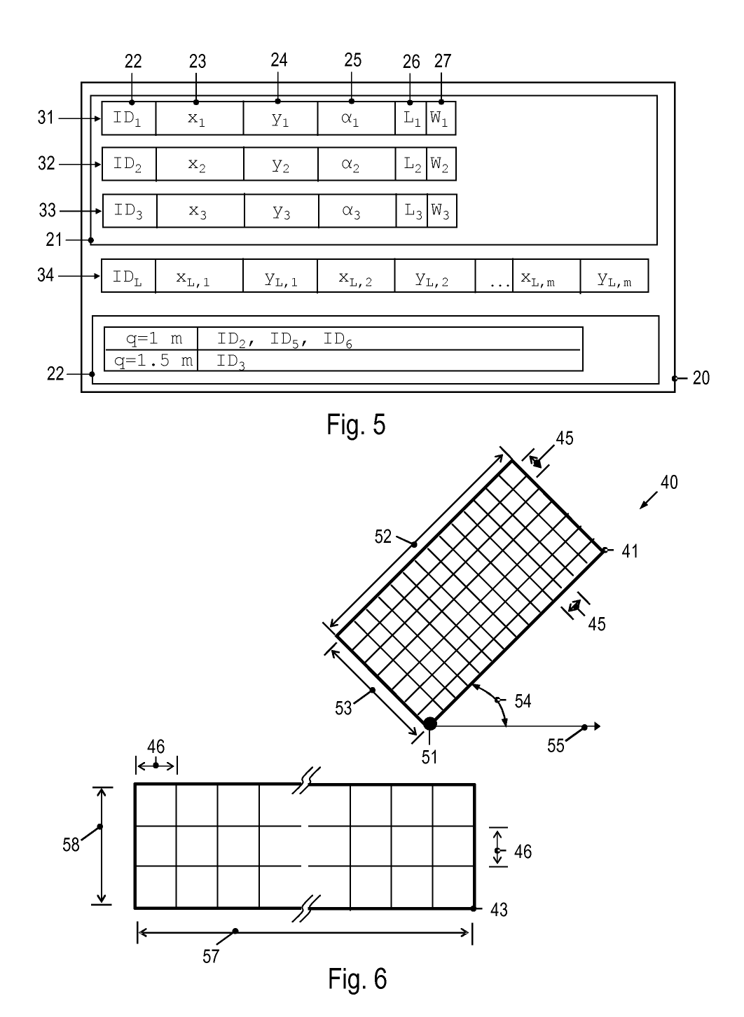

The length indicator Lₘ and the width indicator Wₘ may respectively define an integer included in the interval from 0 to 255. The length and width of a building are defined in a discretized manner by the length indicator and the width indicator, respectively. To determine the length of the building, the processing device of the navigation device may multiply the length indicator by a quantization step size. To determine the width of the building, the processing device of the navigation device may multiply the width indicator by the quantization step size. Different buildings may have different quantization step sizes, as will be explained in more detail with reference to FIG. 5 to FIG. 15. A default quantization step size may be used to determine the dimensions of the footprint unless a dedicated quantization step size is indicated in the database. The default quantization step size may be 0.5 meters, for example.

FIG. 4 illustrates a portion of an electronic map generated by the processing device 2. The processing device 2 generates a graphical representation of a footprint 41 of a first building from the footprint data 31. A length 52 of the footprint is determined by multiplying the length indicator L₁ by the quantization step size 45. A width 53 of the footprint is determined by multiplying the width indicator W₁ by the quantization step size 45. The position of the building in a world reference system determines where the graphical representation of the footprint 41 is shown on the electronic map. For illustration, the position information may define coordinates of a corner 51 of the rectangular footprint, which may be used for positioning the graphical representation of the footprint 41 on the electronic map. An orientation of the footprint 41 may be defined by the orientation information. The orientation information may define an angle 54 between a coordinate axis 55 and a side of the footprint 41 having a length defined by the length indicator.

The processing device 2 generates a graphical representation of a footprint 42 of a second building from the footprint data 32. A length 57 of the footprint 42 is determined by multiplying the length indicator L₂ by the quantization step size 45. A width 58 of the footprint 42 is determined by multiplying the width indicator W₂ by the quantization step size 45. The position of the building in a world reference system determines where the graphical representation of the footprint 42 is shown on the electronic map. The position information may define coordinates of a corner 56 of the footprint 42.

For buildings which have a footprint which is not rectangular or which cannot be decomposed into plural rectangles, the processing device 2 generated a graphical representation of the footprint 44 from the vertex coordinates stored in the footprint data 34.

While FIG. 4 shows a two-dimensional electronic map on which building footprints are displayed in plan view, the footprint data 31-33 may also be used to generate three-dimensional representations of buildings. To this end, the database may include information on building heights and/or textures of building faces. The footprint data 31-33 defines the baseline of the building from which vertical faces extend.

By limiting the data fields in which the length indicator and the width indicator may be stored to a size of one byte only, only a limited number of different indicator values may be stored. However, for the vast majority of buildings, the different indicator values accommodated by a bit octet are sufficient to generate truthful representations of the building. For illustration, for a default quantization step size of 0.5 meters, footprint lengths and footprint widths up to 127.5 meters may be defined with a resolution of 0.5 meters.

To accommodate greater structures and/or provide a more fine-grained quantization, a quantization step size which is greater than or less than the default quantization step size may be selectively defined for some buildings having rectangular footprints.

To display a building on an electronic map, a quantization step size may be determined for the building. A length of a rectangular portion of the footprint may be determined as a product of the length indicator and the quantization step size. A width of the rectangular portion may be determined as a product of the width indicator and the quantization step size.

The database may store a quantization step size only for a sub-set of the plurality of buildings.

In a navigation device or method of embodiments, the quantization step size may be set equal to a default quantization step size if the building is not included in the sub-set.

In a navigation device or method of embodiments, the quantization step size stored in the database may be retrieved from the database if the building is included in the sub-set.

In a navigation device or method of embodiments, the footprint data may be stored in a first table and information on the quantization step size may be stored in a second table different from the first table.

This will be explained in more detail with reference to FIG. 5 to FIG. 7.

FIG. 5 is a schematic representation of a database 20 which includes data defining building footprints. The database 20 may be stored in the storage device 3 of the navigation device 1. The database 20 includes a data section 21 in which footprint data for buildings having rectangular footprints are stored, as explained with reference to FIG. 3. The data section 21 may be a table.

The database 20 includes further data 22 defining a quantization step size for a sub-set of the buildings represented by the data section 21. A quantization step size may be included in the further data 22 selectively only if it is greater or less than a default quantization step size. The further data 22 may be a second table separate from the table which includes the footprint data 31-33.

The further data 22 may associate a quantization step size q with the buildings to which the respective quantization step size applies. In the illustrated implementation, a quantization step size q of 1 meter is defined for and applies to buildings having identifiers ID₂, ID₅, and ID₆. A quantization step size q of 1.5 meters is defined for and applies to a building having identifier ID₃. The quantization step sizes defined by the further data 22 are used to determine a size of a building footprint on an electronic map. To this end, the quantization step size defined by the further data 22 is combined with the length indicator and the width indicator, if the further data 22 indicates that a quantization step size different from the default quantization step size applies to the respective building.

FIG. 6 illustrates a portion of an electronic map generated by the processing device 2. The processing device 2 generates a graphical representation of a footprint 41 of a first building from the footprint data 31. No specific quantization step size is defined for the first building in the further data 22. The dimensions of the footprint 41 of the first building are determined by multiplying the length indicator L₁ by the default quantization step size 45, and by multiplying the width indicator W₁ by the default quantization step size 45.

The processing device 2 generates a graphical representation of the footprint 43 of another building from the footprint data 33. A quantization step size different from the default quantization step size is defined for this building in the further data 22. The processing device 2 retrieves information on the quantization step size from the database. The processing device 2 determines a length 57 of the footprint 43 by multiplying the length indicator L₃ by the retrieved quantization step size 46. The processing device 2 determines a width 58 of the footprint 43 by multiplying the width indicator W₃ by the retrieved quantization step size 46. The position of the graphical representation of the footprint 43 on the electronic map is determined based on the position information, as explained with reference to FIG. 4. The orientation of the graphical representation 43 on the electronic map is determined based on the orientation information, as explained with reference to FIG. 4.

In the implementation of FIG. 5, information on quantization step sizes may be stored separately from the footprint data. In other implementations, the information on the quantization step size may be included in the footprint data. To keep storage space requirements moderate, the information on the quantization step size may be stored selectively only for the footprint data for a building for which the quantization step size does not have the default value. The quantization step size may be defined as a flexible attribute.

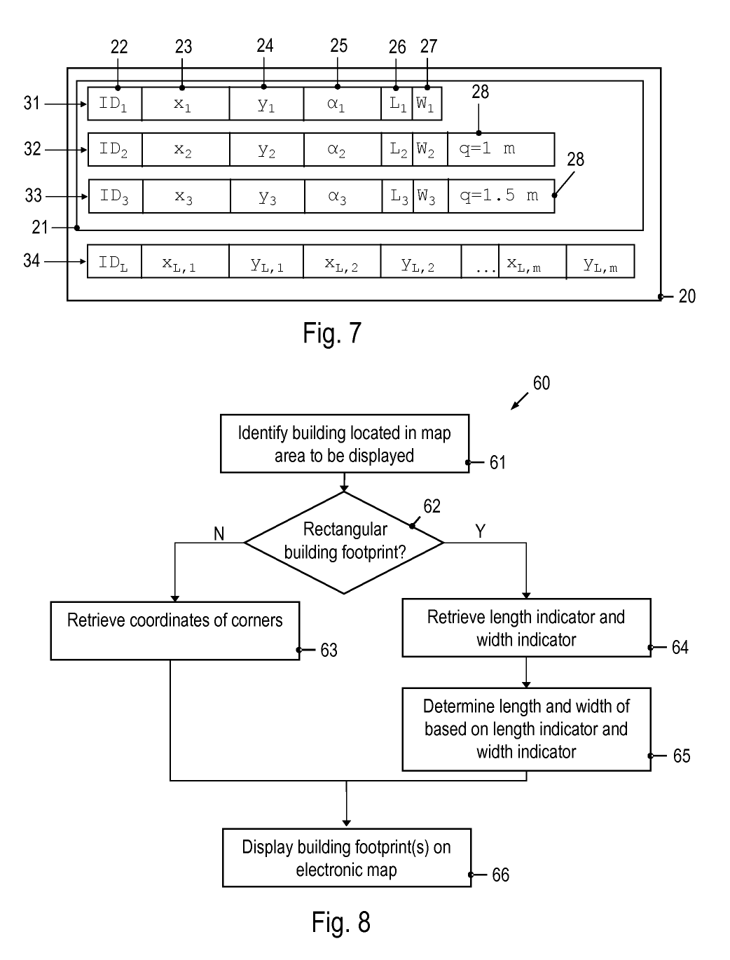

FIG. 7 illustrates database 20 which includes information on quantization step sizes for buildings having rectangular footprints. The footprint data 32 includes a data field 28 indicating that the quantization step size for the footprint has a value different from the default quantization step size. Similarly, the footprint data 33 includes a data field 28 indicating that the quantization step size for the footprint has a value different from the default quantization step size. The data field 28 may have a length of one byte to indicate one of various different quantization step sizes.

FIG. 8 is a flow chart of a method 60 of outputting an electronic map. The method 60 may be performed by the processing device 2 of the navigation device 1. The processing device 2 may control the output interface 4 for displaying buildings on an electronic map.

At 61, the buildings located in a map area to be displayed are identified. For illustration, the database 10 of the navigation device 1 may be organized in accordance with a tiling. The buildings stored in a tile which overlaps with the map area to be displayed may be identified.

At 62, it is determined whether a building has a rectangular footprint. The determining at 62 may be performed based on whether an index of the database points towards a table which is provided to store footprint data only for buildings which have a rectangular footprint. In other implementations, the determining step at 62 may be modified such that it is determined whether the building has a footprint which is composed of rectangular portions only.

At 63, if the building does not have a rectangular footprint, the coordinates of the corners of the footprint may be retrieved from the database. In other implementations, the coordinates of one corner and the direction vectors of plural edges of the footprint may be retrieved.

At 64, if the building is determined to have a rectangular footprint, the length indicator and the width indicator are retrieved from the database. The length indicator may be a bit octet stored in a single byte. The width indicator may be another bit octet stored in another single byte.

At 65, the length of the rectangular footprint may be determined based on the length indicator. Determining the length may comprise multiplying the length indicator by a quantization step size. The width of the rectangular footprint may be determined based on the width indicator. Determining the width may comprise multiplying the width indicator by the quantization step size. Determining the length and width may comprise determining whether a quantization step size is stored for the building in the database. If no quantization step size is stored, a default quantization step size is used to determine the dimensions of the footprint from the length indicator and the width indicator. If a quantization step size is stored, the quantization step size may be retrieved and used to determine the dimensions of the footprint from the length indicator and the width indicator.

The positions of all four corners of the rectangular footprint may be calculated from the determined length, the determined width, position information defining a position of one corner of the rectangular footprint, and orientation information defining the orientation of the rectangular footprint.

At 66, the building footprint may be displayed on an electronic map. The processing device 2 may compute a graphics which is to be output via the optical output device 3. The graphics includes a two-dimensional or three-dimensional representation of the building. The building displayed on the map has a footprint as defined by the corner coordinates retrieved at step 63 or as defined by the footprint data processed at steps 64 and 65.

The footprint may be scaled in dependence on a size of the display area and/or a zoom factor set for the electronic map.

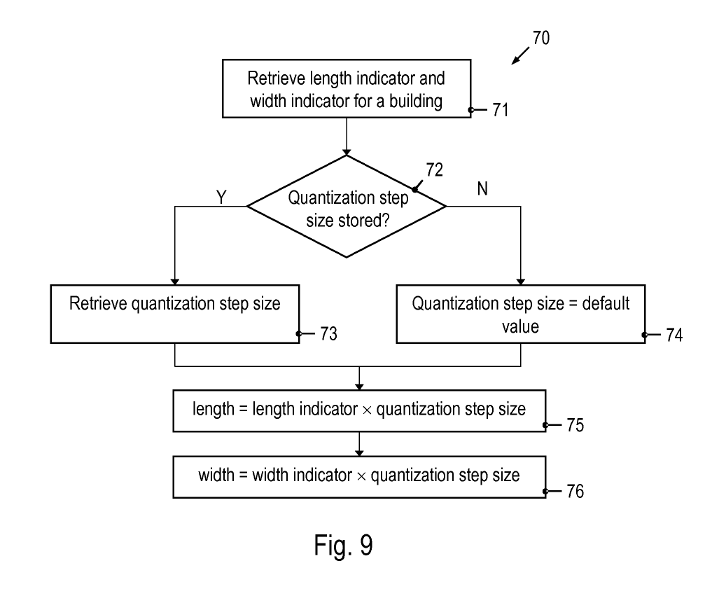

FIG. 9 is a flow chart of a procedure 70 which illustrates the processing of footprint data of a building having a rectangular footprint. The procedure 70 may be performed by the processing device 2 of the navigation device 1. The procedure 70 may be used to implement steps 64 and 65 in the method 60.

At 71, the length indicator and width indicator are retrieved from the footprint data for a building having a rectangular footprint. The length indicator is stored in a single byte. The width indicator is stored in another single byte. The length indicator may define an integer value from the interval between 0 and 255. The width indicator may define another integer value from the interval between 0 and 255.

At 72, it is determined whether the database indicates a quantization step size for the building. If a quantization step size is stored for the building, the quantization step size is retrieved at step 73. If no quantization step size is stored for the building, the quantization step size is set to a default value at step 74.

At 75, the length of the rectangular portion of the footprint is determined by multiplying the retrieved length indicator by the quantization step size. At 76, the width of the rectangular portion of the footprint is determined by multiplying the retrieved width indicator by the quantization step size.

The footprint data having a length indicator and a width indicator may be used for buildings having a rectangular footprint. This was explained in detail with reference to FIG. 3 to FIG. 9. Additionally or alternatively, corresponding techniques may also be used to define the footprint of buildings which are composed of plural rectangular portions.

In a navigation device or method of embodiments, the footprint of a building is composed of a rectangular portion and a further rectangular portion. The footprint data may include a length indicator and a width indicator defining a length and width, respectively, of the rectangular portion. The footprint data may comprise a further length indicator indicating a length of the further rectangular portion, the further length indicator being stored in a further single byte. The footprint data may comprise a further width indicator indicating a width of the further rectangular portion, the further width indicator being stored in another further single byte.

It is possible that the coordinates of a corner of the further rectangular portion are stored in the database. In other implementations, a simplified and more compact way of defining the position of the further rectangular portion may be employed. To this end, the footprint data for the building may comprise a side indicator indicating one side of the rectangular portion, and a offset indicator indicating a position on the one side of the rectangular portion.

The offset indicator may be stored in a single byte. The offset indicator may indicate a position on one of the sides of the rectangular portion at which one corner of the further rectangular portion is located. The offset indicator may define this position in units of the quantization step size for the respective building.

Building footprints which can be decomposed into several rectangular portions may thereby be also stored in a compact form.

FIG. 11 is a schematic representation of database 20 which includes data defining building footprints. The database 20 may be stored in the storage device 3 of the navigation device 1. The database 20 includes a data section 21 with footprint data 31, 32 configured as explained with reference to FIG. 3. The data section 21 may be a table. The footprint data 31, 32 respectively defines the footprint of a building which is composed of one single rectangular portion.

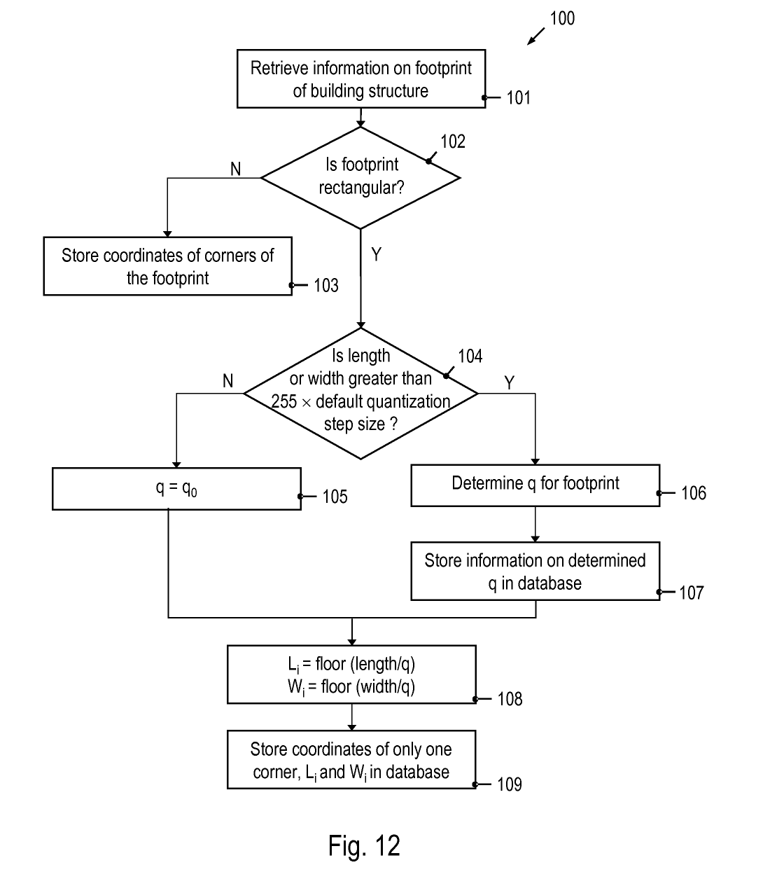

The database 20 includes footprint data 33 for another building. The footprint data 33 represents a footprint of a building which is composed of several rectangular portions. These portions will be referred to as “first rectangular portion” and “further rectangular portion” in the context of FIG. 11 and FIG. 12. The footprint data includes position information, orientation information, and a length indicator and width indicator for the first rectangular portion stored in data fields 23-27. This data may be defined as explained with reference to FIG. 3 to FIG. 9. The length indicator L₃ and the width indicator W₃ define the length and width, respectively, of the first rectangular portion of the footprint in units of a quantization step size.

The footprint data 33 includes a further length indicator L_{f} and a further width indicator W_{f}. The further length indicator L_{f} indicates a length of the further rectangular portion in units of the quantization step size. The further width indicator W_{f} indicates a width of the further rectangular portion in units of the quantization step size. The further length indicator L_{f} is stored in a further single byte 83. The further width indicator W_{f} is stored in another further single byte 84. The further length indicator L_{f} and the further width indicator W_{f} is respectively defined by at most eight bits such that it can be stored in one byte.

The position at which the further rectangular portion attaches to the first rectangular portion may also be stored in a compact way. The footprint data 33 may include an indicator s indicating a side of the first rectangular portion. The indicator s may have two bits. The indicator s may be stored in one byte 81. The indicator s indicates one of the four sides of the first rectangular portion on which the further rectangular portion abuts.

The footprint data 33 may include an offset indicator of which defines an offset between a corner of the first rectangular portion and a corner of the further rectangular portion along the side indicated by the indicator s. The offset indicator of may be a bit octet. The offset indicator of may be stored in one byte 82. The offset indicator of may define a distance from a corner of the first rectangular portion in units of the quantization step size.

When generating an electronic map on which the building represented by footprint data 33 is to be displayed, the processing device 2 may determine the footprint of the building to be the union of the first rectangular portion and the further rectangular portion. The area covered by the first rectangular portion may be determined from the position information, the orientation information, the length indicator and the width indicator. The position at which the further rectangular portion attaches to the first rectangular portion may be determined based on the side indicator s and the offset indicator o_{f}. The outer dimensions of the further rectangular portion may be determined from the further length indicator and the further width indicator.

FIG. 11 shows a portion of an electronic map which includes a graphical representation of a footprint which is composed of several rectangular portions. The electronic map may be generated by the processing device 2 based on footprint data 33 which defines several rectangular portions.

The position information defines a position 93 of a corner of a first rectangular portion 91. A length 94 of the first rectangular portion 91 is determined by multiplying the length indicator and a quantization step size 45. A width 95 of the first rectangular portion 91 is determined by multiplying the width indicator and the quantization step size 45. An orientation of the first rectangular portion 91 may be determined by orientation information included in the footprint data 33.

The footprint comprises a further rectangular portion 92. The location of a corner 97 of the further rectangular portion 92 is defined by the side indicator and the offset indicator. The offset indicator defines a position of the corner 97 on one of the sides of the first rectangular portion 91 in units of the quantization step size 45. The offset indicator may define an offset 96 from a corner of the first rectangular portion. The offset 96 may be obtained by multiplying the offset indicator and the quantization step size 45.

A length 98 of the further rectangular portion 92 may be determined by multiplying the further length indicator and the quantization step size 45. A width 99 of the further rectangular portion 92 may be determined by multiplying the further width indicator and the quantization step size 45. The union of the first rectangular portion 91 and the further rectangular portion 92 defines the footprint of the building.

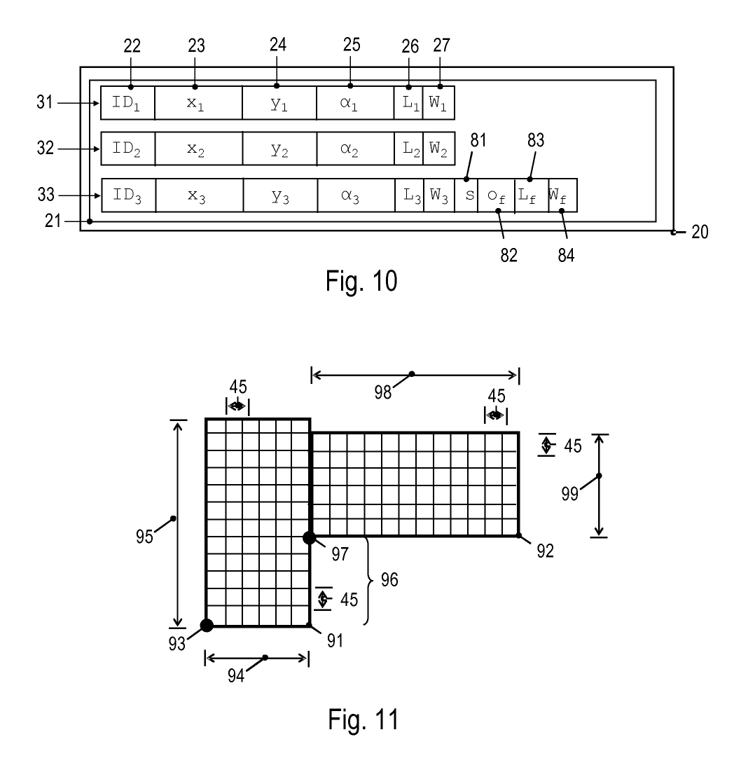

While a building footprint composed of two rectangular portions is illustrated in FIG. 11, the techniques described with reference to FIG. 10 and FIG. 11 may also be used for building footprints composed of three rectangular portions or composed of more than three rectangular portions.

FIG. 12 is a flow chart of a method 100 of generating a database according to an embodiment. The method 100 may be performed by a server or another computing device. The method 100 may be performed by a computing device which is separate from the navigation device. Footprint data determined in the method 100 may be stored in several navigation devices.

At 101, information on a footprint of a building structure is retrieved. The information may be retrieved from a cadastral map, from an aerial view, from manual input, or from other sources.

At 102, it is determined whether the footprint is rectangular. If the footprint is not rectangular, the coordinates of all corners of the footprint may be stored at 103. If the footprint is rectangular, the method proceeds to 104.

At 104, it is determined whether a length or a width of the rectangular footprint is greater than 255 times a default quantization step size q₀. The default quantization step size q₀ may be 0.5 meters, for example. If both sides of the rectangular footprint are at most 255 times the default quantization step size q₀ the method proceeds to step 105. At 105, the quantization step size q is set equal to the default quantization step size q₀.

If at least one of the sides of the rectangular footprint is greater than 255 times the default quantization step size q₀ the method proceeds to step 106.

At 106, the quantization step size used for the footprint is determined. The quantization step q size may be determined as integer multiple of the default quantization step size q₀, e.g. according to

q=m·q₀ (1)

where m is the smallest integer number for which

255·m·q₀·max(l,w)>0 (2)

is fulfilled. The quantities l and w denote the length and width, respectively, of the rectangular footprint. The function max (·) denotes the maximum of its arguments.

At 107, information associating the determined quantization step size q with the building is stored in the database. For illustration, if quantization step sizes are stored in a separate table 22 as explained with reference to FIG. 5, a table entry may be generated or updated to associate the quantization step size q with the respective building. If quantization step sizes are stored as a flexible attribute as explained with reference to FIG. 7, the flexible attribute may be added to the footprint data for the building.

At 108, the length indicator and the width indicator are determined for the rectangular footprint. The length indicator Lᵢ may be determined as

Lᵢ=floor(l/q). (3)

The width indicator Wᵢ may be determined as

Wᵢ=floor(w/q). (4)

Here, floor (·) denotes the floor function, which has a value equal to the largest integer which is not greater than its argument.

The determined length indicator is an integer in the interval from 0 to 255, inclusive, which may be represented by a bit octet. The determined width indicator is an integer in the interval from 0 to 255, inclusive, which may be represented by a bit octet.

At 109, the coordinates of only one corner of the rectangular footprint, the length indicator and the width indicator are stored in the database as the footprint data. Orientation information may optionally also be included in the footprint data.

Steps 101-109 may be repeated for plural buildings.

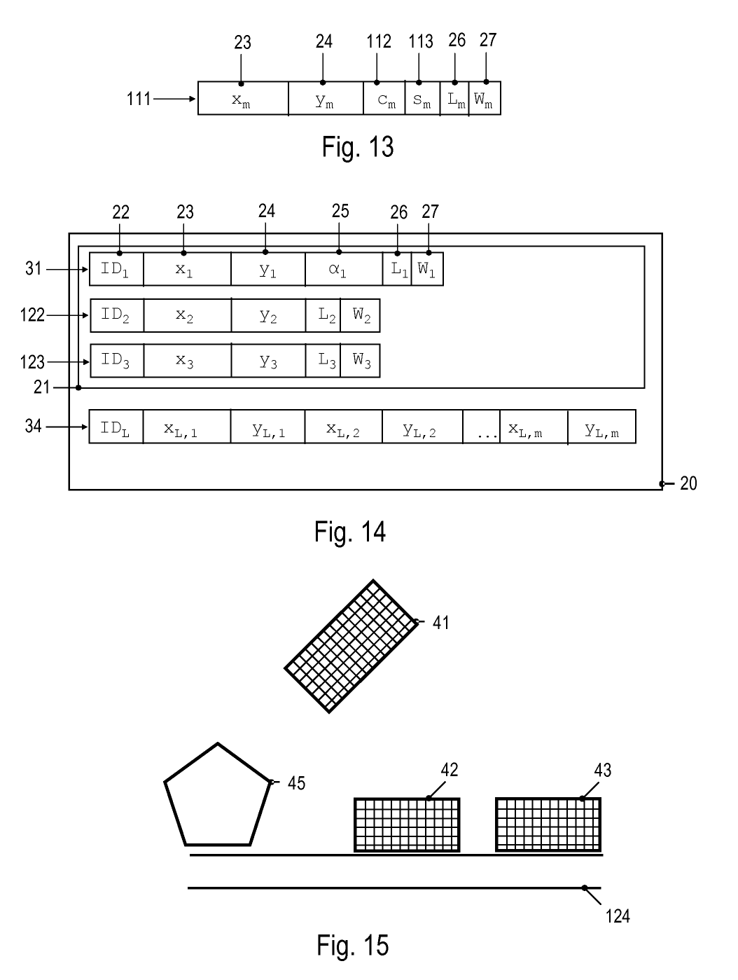

Various modifications may be made to the specific format and the data stored in the footprint data. For illustration, the orientation information may be stored in various formats or does not need to be stored at all, as will be explained with reference to FIG. 13 to FIG. 15.

FIG. 13 is a schematic diagram of footprint data 111 which may be used in a database according to embodiments. The footprint data 111 defines a rectangular portion of a building footprint. The footprint data 111 includes position information stored in data fields 23, 24, a length indicator stored in one byte 26 and a width indicator stored one byte 27. This data may be configured as explained with reference to FIG. 3 to FIG. 12.

The footprint data 111 also stores direction information. To define the direction of the rectangular portion, the footprint data 111 stores a value cₘ indicating the cosine of the angle αₘ between a side of the rectangular portion and a coordinate axis, cₘ=cos (αₘ). The footprint data 112 stores another value sₘ indicating the sine of the angle αₘ between a side of the rectangular portion and a coordinate axis, sₘ=sin (αₘ). By storing the cosine cₘ and the sine sₘ of the angle, the coordinates of all corners of the rectangular portion may be readily determined by performing multiplication and addition operations in the navigation device. Further, it may be sufficient to reserve a single byte 112 for storing the cosine cₘ and another single byte 113 for storing the sine sₘ. The different values which can be represented by such a bit octet would allow the cosine and sine to be defined with a precision of ±0.002, which would be sufficient for generating electronic maps in most cases.

In still other implementations, the footprint data does not need to include orientation information for all building footprints. For illustration, a convention may be used that a building has a longer side parallel to a road segment at which the building is positioned when no orientation information is stored in the database. This is illustrated in FIG. 14 and FIG. 15.

FIG. 14 illustrates a database 20 which stores footprint data. A data section 21 includes footprint data for buildings having a footprint which is a rectangular portion or which may be decomposed into rectangular portions. The database 20 includes footprint data 31 configured as explained with reference to FIG. 3. The database 20 may also include footprint data 35 for a building which has a footprint which cannot be decomposed into rectangular portions.

The database 20 includes footprint data 122, 123 respectively defining a rectangular footprint of a building. The footprint data 122, 123 respectively includes position information defining a position of a point of the footprint. The footprint data 122, 123 respectively includes a length indicator which defines a length of the rectangular portion in units of a quantization step size. The footprint data 122, 123 respectively includes a width indicator which defines a width of the rectangular portion in units of the quantization step size. The footprint data 122, 123 does not include orientation information. This indicates that the side having a length indicated by the length indicator extends parallel to a boundary of a road segment along which the building is positioned. When outputting an electronic map, the processing device 2 may automatically interpret the omission of the orientation information to mean that a side of the rectangular footprint extends parallel to the road segment at which the building is positioned. In other implementation, the processing device 2 may automatically interpret the omission of the orientation information from the footprint data to mean that a side of the rectangular footprint extends along a pre-defined, fixed direction.

FIG. 15 illustrates an electronic map generated by the navigation device 1. The electronic map may be generated using the database 20 configured as explained with reference to FIG. 14. A graphical representation of a footprint 41 of a building is generated from the footprint data 31. The orientation of the footprint 41 is determined by the orientation information included in the footprint data 31. A graphical representation of a footprint 42 of another building is generated from the footprint data 122. A graphical representation of a footprint 43 of yet another building is generated from the footprint data 123. The footprint data 122, 123 do not include orientation information. The processing device 2 generates the graphical representations of the footprints 42, 43 such that the footprints 42, 43 have a side extending along a direction of a road segment 124 along which the buildings with footprints 42, 43 are positioned.

While devices and methods according to embodiments have been described in detail, modifications may be implemented in other embodiments. For illustration, while embodiments were described in which footprints composed of one or two rectangular portions may be described using a length indicator and a width indicator respectively stored in one byte, footprints composed of three or more than three rectangular portions may be stored in a similar manner. In other implementations, only buildings having a rectangular footprint (i.e., building for which the footprint is a rectangular portion) may have footprint data which stores the length indicator and the width indicator.

For further illustration, while embodiments have been described in which a quantization step size different from a default quantization step size may also be stored in the database, it is not required to accommodate different quantization step sizes. Footprint data comprising a length indicator and a width indicator respectively stored in one byte may be used for building footprints in which both the length and the width are at most equal to 255 times the quantization step size. Footprints of larger buildings may be stored by storing the coordinates of all corners, for example.

For further illustration, while embodiments have been described in which the length and width of a footprint are determined by multiplying the length indicator by the quantization step size and by multiplying the width indicator by the quantization step size, respectively, other techniques may be used to translate the length and width indicators into a length and width, respectively. For illustration, look-up tables may be used which associate different indicator values with different lengths or widths.

Embodiments of the invention may be used for navigation devices. The navigation device may be a vehicle navigation device which is fixedly installed in a vehicle or a mobile navigation device.

1. A navigation device, comprising:
an optical output device;
a database storing data for a plurality of buildings, wherein the data for at least some buildings respectively comprises footprint data defining a footprint of the respective building and comprising:
position information defining a position of the building,
a length indicator indicating a length of a rectangular portion of the footprint, the length indicator being stored in a single byte, and
a width indicator indicating a width of the rectangular portion of the footprint, the width indicator being stored in another single byte and
a processing device coupled to the database and configured to control the optical output device as a function of the position information, the length indicator and the width indicator stored in the database for a building to output a graphical representation of the building.

2. The navigation device of claim 1, wherein the processing device is configured
to determine a quantization step size for the building,
to determine a length of the rectangular portion as a product of the length indicator and the quantization step size and
to determine a width of the rectangular portion as a product of the width indicator and the quantization step size.

3. The navigation device of claim 2, wherein the database stores information on a quantization step sizes for a sub-set of the plurality of buildings.

4. The navigation device of claim 3, wherein the processing device is configured to determine the quantization step size for the building to be a default quantization step size if the building is not included in the sub-set.

5. The navigation device of claim 3, wherein the processing device is configured to retrieve the quantization step size for the building stored in the database if the building is included in the sub-set.

6. The navigation device of claim 3, wherein the footprint data is stored in a first table and wherein the quantization step size for the building is stored in a second table different from the first table.

7. The navigation device of claim 1 any one of the preceding claims, wherein the footprint data further comprises orientation information (defining an orientation of a side of the rectangular portion).

8. The navigation device of claim 7, wherein the orientation information is indicative of an angle enclosed between the side and a coordinate axis.

9. The navigation device of claim 1, wherein the position information includes a first coordinate value and a second coordinate value, the first coordinate value being stored in plural bytes and the second coordinate value being stored in plural other bytes.

10. The navigation device of claim 1, wherein the footprint of the building is composed of the rectangular portion and a further rectangular portion wherein the footprint data further comprises:
a further length indicator indicating a length of the further rectangular portion, the further length indicator being stored in a further single byte, and
a further width indicator indicating a width of the further rectangular portion, the further width indicator being stored in another further single byte.

11. The navigation device of claim 10, wherein the footprint data for the building further comprises:
a side indicator indicating one side of the rectangular portion, and
an offset indicator indicating a position offset on the one side of the rectangular portion, the offset indicator being stored in a single byte.

12. A method of outputting an electronic map, the method comprising:
retrieving data for a building from a database, wherein the database stores data for a plurality of buildings, wherein the data for at least some buildings respectively comprises footprint data defining a footprint of the respective building and comprising:
position information (23, 24) defining a position of the building,
a length indicator indicating a length of a rectangular portion of the footprint, the length indicator being stored in a single byte, and
a width indicator indicating a width of the rectangular portion of the footprint, the width indicator being stored in another single byte; and
outputting a graphical representation of the building via an optical output device, wherein the graphical representation is generated as a function of the position information, the length indicator and the width indicator stored in the database for the building.

13. (canceled)

14. A method of generating a database for a navigation device, the method comprising:
determining whether a footprint of a building is composed of at least one rectangular portion; and
if the footprint is composed of the at least one rectangular portion,
determining a length indicator which has at most eight bits and which indicates a length of a rectangular portion, of the footprint,
determining a width indicator which has at most eight bits and which indicates a width of a rectangular portion,
storing footprint data, for the building in the database, wherein the footprint data is stored such that it includes position information defining a position of the building, the width indicator and the length indicator, wherein the length indicator is stored in a single byte and the width indicator is stored in another single byte.

15. (canceled)

16. The method of claim 13, wherein the database stores information on quantization step sizes for a sub-set of the plurality of buildings.

17. The method of claim 16, wherein determining the quantization step size for the building comprises setting the quantization step size for the building to be a default quantization step size if the building is not included in the sub-set.

18. The method of claim 16, wherein determining the quantization step size for the building comprises retrieving the quantization step size for the building stored in the database if the building is included in the sub-set.

19. The method of claim 16, wherein the footprint data is stored in a first table and wherein the quantization step size for the building is stored in a second table different from the first table.
